(19) United States
(12) Patent Application Publication
(10) Pub. No.: US 2004/0164662 A1
(43) Pub. Date: Aug. 26, 2004

(54) Barrier rib material for display device

(76) Inventors: Seoghyun Cho, Seoul (KR); Kiyeon Lee, Suwon-si (KR); Haesoo Ha, Suwon-si (KR)

Correspondence Address: David A. Einhorn, Esq., Anderson Kill & Olick, P.C., 1251 Avenue of the Americas, New York, NY, 10020, US

(21) Appl. No.: 10/782,225

(22) Filed: Feb. 19, 2004

(30) Foreign Application Priority Data
Feb. 20, 2003 (KR) 2003-0010629

(51) Int. Cl. H01J 1/62

(52) U.S. Cl. 313/292

(57) ABSTRACT

The present invention provides a barrier rib material for forming a discharge space for a display device such as PDP and LCD, and the inventive barrier rib material is characterized by comprising water glass (Na₂SiO₂) and an inorganic filler, containing no low melting glass nor a binder resin. The inventive barrier rib material can be simply prepared by spreading a composition for the barrier rib material on a substrate via a nozzle and drying the spread composition at a low temperature of below 200° C., and therefore, can be beneficially used in the mass production of the display devices.

### FIELD OF THE INVENTION

The present invention relates to a barrier rib material comprising water glass and an inorganic filler, and to a simple method of preparing barrier ribs in a display device using same.

### BACKGROUND OF THE INVENTION

A liquid crystal display (LCD) or plasma display panel (PDP) unit has a discharge space maintained at a reduced pressure condition, which can be typically formed by seal-tightly attaching a front plate to a rear plate using an adhesive composition. A glass composition having a low melting point for the adhesion of a panel to a funnel of a CRT display is disclosed in Japanese Laid-open Patent Publication No. 2000-030614A. In this patent, a Pb—B₂O₃ based glass adhesive is used to adhere the panel to the funnel by heating at 430 to 450° C. for 30 to 40 min, and the laminated product is evacuated at 300 to 380° C. to obtain a high vacuum of below 10⁻⁶ torr. Further, Japanese Laid-open Patent Publication No. 2000-011929 discloses a preparing method of a vacuum fluorescent display (VFD), field emission display (FED) or LCD using such a glass adhesive having a low melting point.

However, such low melting glass adhesive contains PbO, which is harmful to the worker who handles the glass and to the environment. Accordingly, the development of a glass adhesive containing no PbO is required.

In this regard, Japanese Laid-open Patent Publication No. 1995-316398 teaches the use of a mixture of an alkylphenyl silicon resin as an organic binder and an inorganic filler at 200 to 400° C., but this adhesive material has the problems that the evacuating process cannot be carried out at above 380° C. due to a low decomposition temperature of the organic binder and the alkylphenyl silicon resin is costly.

A back-light unit for LCD has been conventionally produced by arranging pipe-type lamps in series, which makes the production process complicated. Further, an LCD back-light unit comprising spacers, which are also known as barrier ribs, is difficult to be scaled up because of its complicated preparing process. Accordingly, there has existed a need to develop a method of forming a barrier rib for a large scale LCD in a simple and economical way.

In case of a PDP device, there has been developed a method of preparing a barrier rib for forming a discharge space comprising spreading an inorganic adhesive paste containing a glass adhesive of a low melting point and an inorganic filler onto the entire surface of a glass substrate, sintering the spread paste, exposing the sintered paste in a given pattern, and sandblasting the pattern formed. However, such a method requires complicated process steps, and it is not directly applicable to an LCD due to the differences in the spacing and the structure of the barrier ribs and also in the operating principles between PDP and LCD.

### SUMMARY OF THE INVENTION

Accordingly, it is an object of the present invention to provide a novel barrier rib material, which can be advantageously used to form a discharge space in a display device.

Further, it is another object of the present invention to provide a convenient and simple method for preparing barrier ribs in a display device at a low cost.

In accordance with one aspect of the present invention, there is provided a barrier rib material for a display device comprising 15 to 50% by weight of water glass (Na₂SiO₂) and 50 to 85% by weight of an inorganic filler.

In accordance with a further aspect of the present invention, there is provided a method for preparing barrier ribs in a display device comprising ejecting a composition for the barrier rib material on a glass substrate through a nozzle to form a desired pattern of the barrier ribs on the substrate and drying the pattern of barrier ribs at a temperature in the range of room temperature to 200° C.

In accordance with a still further aspect of the present invention, there is provided a liquid crystal display (LCD) device comprising the barrier ribs formed by said method.

### BRIEF DESCRIPTION OF THE DRAWINGS

The above and other objects and features of the present invention will become apparent from the following description of the invention, when taken in conjunction with the accompanying drawings, which respectively show:

FIG. 1: a view of the longitudinal cross-section of an LCD backlight unit comprising barrier ribs.

FIG. 2: a schematic view showing the preparative procedure of barrier ribs using an ejection nozzle in accordance with the present invention.

### DETAILED DESCRIPTION OF THE INVENTION

The present invention provides a barrier rib material for forming a discharge space for a display device such as PDP and LCD, and the inventive barrier rib material is characterized by comprising water glass (Na₂SiO₂) and an inorganic filler, containing no low melting glass nor a binder resin. The inventive barrier rib material can be simply prepared by spreading a paste composition for the barrier rib material on a substrate via a nozzle and drying the spread paste at a relatively low temperature, and therefore, it can be beneficially used in forming a barrier rib or spacer in the mass production of a display device.

Specifically, the inventive barrier rib material comprises the water glass and the inorganic filler in amounts of 15 to 50% by weight and 50 to 85% by weight, respectively.

The barrier rib material may be formed from a paste composition comprising 20 to 80 wt % of a water glass solution containing a water glass in an amount of 60 to 90 wt %, and 20 to 80 wt % of an inorganic filler. If the content of water glass is less than the lower limit, the viscosity of the composition becomes excessively low and thus it is difficult to form a rib structure, while if the water glass content is more than the upper limit, the viscosity of the composition becomes too high to be dispensed from a nozzle.

The water glass uniquely used in the present invention is well known and commercially available. The water glass can be easily diluted by the addition of water, thus facilitating control of the viscosity and the concentration of the composition for forming a barrier rib. Further, it does not release any harmful materials during handling the composition.

Representative examples of the inorganic filler include alumina (Al₂O₃), zirconia, cordierite, silica(SiO₂), eucryptite and spodumen. The inorganic filler may have an average size in the range of 0.1 to 30 μm. If the average size of the inorganic filler is less than 0.1 μm, the dispersion of the inorganic filler is difficult and the prepared barrier rib easily cracks. Meanwhile, if the average size of the inorganic filler is greater than 30 μm, the paste composition is difficult to spread on the glass plate because of its thixotropic property.

The barrier rib material can be simply formed on a substrate by ejecting the composition for the barrier rib material in a desired pattern of the barrier ribs through a nozzle and drying the pattern of barrier ribs. The drying may be conducted at a low temperature in the range of room temperature to 2002° C.

When the barrier rib material is employed to form a space between glass plates, it can impart a good sealing property, so it can be beneficially employed in the fabrication of barrier ribs or spacers for the discharge space of PDP, VFD, FED or LCD.

In addition, since the composition of the barrier rib material has a good adhesive strength, it may be used as a common adhesive, e.g., for adhering various glass panels.

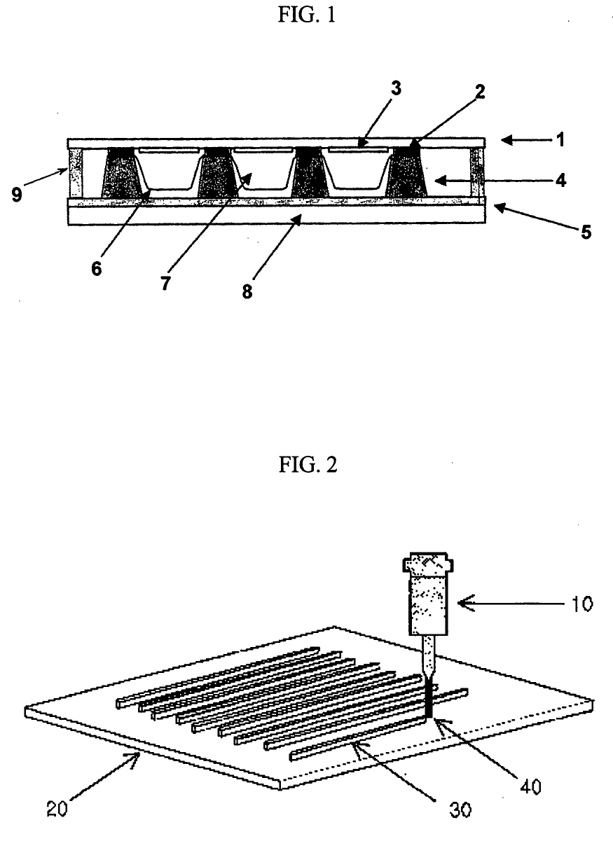

The longitudinal cross-section of an LCD backlight unit comprising barrier ribs is illustrated in FIG. 1, wherein a rear glass plate 8 and a front glass plate 1 are adhered by a sealant 9 to form a discharge space 7 for an LCD; a reflecting plate 5 is positioned on the inside of the rear glass plate 8; barrier ribs 4 are provided on the reflecting plate 5; and the sealing paste 2 is filled between the top of the barrier ribs 4 and the front plate 1. Further, fluorescent substances 3 and 6 for emitting light in the discharge space are coated on the front plate 1 and on the inside of the reflecting plate 5, respectively.

Referring to FIG. 2, in accordance with the present invention, a barrier rib for an LCD can be prepared by spreading and drying the inventive paste containing water glass and an inorganic filler through an ejection nozzle.

As mentioned previously, the inventive paste composition for the barrier rib generates no volatile harmful materials in the working environment. Further, the preparation method according to the present invention has an advantage over the previous methods in that it can be conducted at a relatively low temperature of 200° C. Therefore, the inventive method can be utilized for the mass production of display devices such as PDP, VFD and FED etc.

The present invention will be described in further detail by the following Examples, which are, however, not intended to limit the scopes of the present invention.

### EXAMPLE 1

60 g of a mixture containing 70 wt % water glass and 30 wt % distilled water, 30 g of alumina granules (ALM41, a product of SMITOMO, Japan) and 40 g of a zircon powder having an average diameter of 8.0 μm were mixed together to obtain an inorganic adhesive paste.

The resulting inorganic adhesive paste was spread to the entire surface of a 50 mm×50 mm×2.8 mm soda lime glass plate to a thickness of 2.5 mm, and dried at 120° C. for 30 min. Then, the adhesive strength of the resulting specimen was tested by applying shearing stress to the inorganic adhesive layer and determining the loading at which the layer is broken with a peeling force tester. The test result is shown in Table 1.

Further, as shown in FIG. 2, the inorganic adhesive paste 40 was applied to a soda lime glass 20 (a rear glass plate) in a pattern using a nozzle 10, to provide a barrier rib 30, and another soda lime glass (a front glass plate) having the same size as the rear glass plate was covered thereon, and the resulting laminate was dried for 30 min. at 120° C. to obtain a discharge structure for an LCD backlight panel. The discharge structure was heated to 380° C. in a furnace and evaporated under 10⁻⁷ torr and then subjected to a leakage test. The test result is also listed in the Table 1.

### EXAMPLE 2

The procedure of Example 1 was repeated except that 30 g of a mixture composed of 83 wt % water glass and 17 wt % distilled water, 52 g of a zircon powder having an average diameter of 8.0 μm and 18 g of a SiO₂ powder having an average diameter of 7.4 μm were used to obtain an inorganic adhesive paste.

### EXAMPLE 3

The procedure of Example 1 was repeated except that 30 g of a mixture composed of 83 wt % water glass and 17 wt % distilled water, 25 g of a SiO₂ powder having an average diameter of 7.4 μm and 55 g of a cordierite fine powder having an average diameter of 3.0 μm (previously made by mixing MgO, Al₂O₃ and SiO₂ in a 2:2:5 molar ratio, sintering at 1400° C. for 2 hrs, grinding with a ball mill and filtering with a screening of 150 meshes) were used to obtain an inorganic adhesive paste.

### EXAMPLE 4

The procedure of Example 1 was repeated except that 30 g of a mixture composed of 80 wt % water glass and 20 wt % distilled water, 50 g of a zircon fine powder having an average diameter of 8.0 μm and 30 g of a β-eucryptite fine powder having an average diameter of 5.0 μm (previously made by mixing Li₂O, Al₂O₃ and SiO₂ in a 1:1:2 molar ratio, sintering at 1300° C. for 2 hrs, grinding with a ball mill and filtering with a screen of 150 meshes) were used to obtain an inorganic adhesive paste.

### EXAMPLE 5

The procedure of Example 1 was repeated except that 30 g of a mixture composed of 80 wt % water glass and 20 wt % distilled water, 42 g of an alumina fine powder (ALM 41, a product of SMITOMO, Japan) having an average diameter of 1.5 μm and 32 g of a SiO₂ powder having an average diameter of 7.4 μm were used to obtain an inorganic adhesive paste.

### EXAMPLE 6

The procedure of Example 1 was repeated except that 30 g of a mixture composed of 70 wt % water glass and 30 wt % distilled water, 60 g of a zircon fine powder having an average diameter of 8.0 μm and 55 g of a cordierite fine powder having an average diameter of 3.0 μm (previously made by mixing MgO, Al₂O₃ and SiO₂ in a 2:2:5 molar ratio, sintering at 1400° C. for 2 hrs, grinding with a ball mill and filtering with a screening of 150 meshes) were used to obtain an inorganic adhesive paste.

### COMPARATIVE EXAMPLE

The procedure of Example 1 was repeated except that a PbO—B₂O₃ based low melting point glass powder was mixed with a cordierite powder as prepared in Example 3 in a 8:2 mix ratio by weight to prepare a control adhesive paste, and it was sintered at 430° C. after being applied to the glass plate.

TABLE 1

| | | | | | | | Comparative |
|---|---|---|---|---|---|---|---|
| | Example 1 | Example 2 | Example 3 | Example 4 | Example 5 | Example 6 | Example |
| Mixing ratio | | | | | | | |
| (wt %) | | | | | | | |
| Water glass | 70 | 83 | 83 | 80 | 80 | 70 | Glass powder |
| Distilled water | 30 | 17 | 17 | 20 | 20 | 30 | having low |
| | | | | | | | m.p. based on |
| | | | | | | | PbO—B₂O₃ |
| Amount(g) | 60 | 30 | 30 | 30 | 30 | 30 | 80(wt %) |
| Inorganic | | | | | | | |
| filler | | | | | | | |
| (g) | | | | | | | |
| Al₂O₃ | 30 | — | — | — | 42 | | |
| Zircon | 40 | 52 | — | 50 | — | 60 | |
| SiO₂ | — | 18 | 25 | — | 32 | | |
| Eucryptite | — | — | — | 30 | — | | |
| Cordierite | — | — | 55 | — | — | 20 | 20(wt %) |
| Adhesive | | | | | | | |
| Composition | | | | | | | |
| Water glass | 37.5 | 26.2 | 33.8 | 23.1 | 24.5 | 20.8 | |
| (wt %) | | | | | | | |
| Inorganic | 62.5 | 73.8 | 66.2 | 76.9 | 75.5 | 79.2 | |
| filler | | | | | | | |
| (wt %) | | | | | | | |
| Adhesion | 13.0 | 11.0 | 14.5 | 12.0 | 15.5 | 12.5 | 10.0 |
| strength | | | | | | | |
| (kgf) | | | | | | | |
| Sintering | 120 | 120 | 120 | 120 | 120 | 120 | 430 |
| temperature | | | | | | | |
| (° C.) | | | | | | | |
| Leakage | x | x | x | x | x | x | x |

As shown in Table 1, according to the present invention, the adhesive paste can be dried at a relatively low temperature of below 200° C. to form a barrier rib, and the barrier rib thus formed has a high adhesive strength, good sealing property, therefore, it can be beneficially used in the fabrication of a planar LCD backlight, PDP, VFD or FED.

While the invention has been described with respect to the above specific examples, it should be recognized that various modifications and changes may be made to the invention by those skilled in the art which also fall within the scope of the invention as defined by the appended claims.

What is claimed is:

1. A barrier rib material for a display device comprising 15 to 50% by weight of water glass (Na₂SiO₂) and 50 to 85% by weight of an inorganic filler.

2. The barrier rib material according to claim 1, wherein the inorganic filler is one or more selected from the group consisting of alumina(Al₂O₃), zirconia, crodierite, silica(SiO₂), eucryptite and spodumen.

3. The barrier rib material according to claim 1, the average diameter of the inorganic filler is in the range of 0.1 to 30 μm.

4. A method for preparing barrier ribs for a display device comprising ejecting a composition of the barrier rib material of claim 1 through a nozzle on a glass substrate to form a desired pattern of the barrier ribs on the substrate and drying the pattern of barrier ribs at a temperature in the range of room temperature to 200° C.

5. The method according to claim 4, wherein the composition comprises 20 to 80 wt % of a water glass solution containing a water glass in an amount of 60 to 90 wt %, and 20 to 80 wt % of an inorganic filler.

6. A liquid crystal display (LCD) device comprising barrier ribs formed of the material according to claim 1.
